(19) United States
(12) Patent Application Publication
(10) Pub. No.: US 2024/0161414 A1
(43) Pub. Date: May 16, 2024

(54) METAVERSE DYNAMIC LOCATION LINKS

(71) Applicant: AT&T Intellectual Property I, L.P., Atlanta, GA (US)

(72) Inventors: Wei Wang, Harrison, NJ (US); Lars Benjamin Johnson, Brooklyn, NY (US); Mikhail Istomin, Brooklyn, NY (US); Rachel Rosencrantz, Seattle, WA (US)

(73) Assignee: AT&T Intellectual Property I, L.P., Atlanta, GA (US)

(21) Appl. No.: 17/987,397

(22) Filed: Nov. 15, 2022

(51) Int. Cl. G06T 19/00; H04L 67/02; H04W 4/02

(52) U.S. Cl. CPC G06T 19/006; H04L 67/02; H04W 4/026

(57) ABSTRACT

Aspects of the subject disclosure may include, for example providing virtual links and/or virtual content to metaverse users based at least in part on the metaverse user's physical location and/or viewing direction. Low resolution images of physical objects expected to be in a field of view of a metaverse user may be matched to actual images of physical objects in a metaverse user's field of view prior to providing virtual links and/or virtual content. Other embodiments are disclosed.

### FIELD OF THE DISCLOSURE

The subject disclosure relates to the presentation of links to metaverse users.

### BACKGROUND

Today, a user may follow a link when they click or otherwise activate a selection that will open a path to a uniform resource locator (URL). For example, a user may activate a link by clicking on it in a web browser when using a computer. Also for example, a user may activate a link by pointing a camera at a physical tag such as a quick response (QR) code that is placed in a physical environment (e.g., a link to a menu in a restaurant window).

Links in public places (e.g., in the form of text, QR codes, etc.) can be covered or replaced (or otherwise compromised) by entities or individuals with ill intent. Such actions may be motivated by a simple desire for vandalism or by an effort to steal views. These actions may also be motivated by an attempt to infect users by re-directing them to sites with drive-by downloads or other such viruses.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating an example, non-limiting embodiment of a system providing a link to a metaverse user in accordance with various aspects described herein.

FIG. 2C is a block diagram illustrating an example, non-limiting embodiment of a system providing virtual content at various resolutions to a metaverse user in accordance with various aspects described herein.

FIG. 2D is a block diagram illustrating an example, non-limiting embodiment of a system providing virtual content to a metaverse user in accordance with various aspects described herein.

FIG. 2E depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for providing metaverse user with links and virtual content. Other embodiments are described in the subject disclosure.

One or more aspects of the subject disclosure include a device, comprising a processing system including a processor, and a memory that stores executable instructions that, when executed by the processing system, facilitate performance of operations. The operations may include determining a physical location of a metaverse user; based at least in part on the physical location of the metaverse user, determining virtual content to be made available to the metaverse user; and providing, to the metaverse user, a link to the virtual content.

One or more aspects of the subject disclosure include a non-transitory machine-readable medium, comprising executable instructions that, when executed by a processing system including a processor, facilitate performance of operations. The operations may include determining a physical location of a metaverse user; determining a viewing direction of the metaverse user; and based at least in part on the physical location and the viewing direction of the metaverse user, providing, to the metaverse user, a link to virtual content associated with an object in a field of view of the metaverse user.

One or more aspects of the subject disclosure include a method that includes determining, by a processing system including a processor, a physical location of a metaverse user; providing, by the processing system, the physical location to a metaverse platform; receiving, by the processing system, a link to virtual content; providing, by the processing system, an indication to the metaverse platform that the metaverse user has interacted with the link to the virtual content; and receiving, by the processing system, the virtual content from a content delivery network.

One or more additional aspects of the subject disclosure include identifying a physical object in a field of view of the metaverse user, and wherein the determining the virtual content is further based at least in part on the physical object in the field of view; presenting an image of the physical object to the metaverse user at a first resolution; and in response to the metaverse user interacting with the link to the virtual content, presenting an augmented image of the physical object to the metaverse user at a second resolution, wherein the second resolution is higher than the first resolution. In some embodiments, the augmented image may include digital artwork, and the determining the physical location of the metaverse user comprises communicating with a 5G network.

One or more additional aspects of the subject disclosure include determining metadata associated with the link; and presenting the metadata to the metaverse user along with the link. The metadata may comprise an age of the link, an access frequency of the link, a total number of accesses of the link, or any combination. Further, the metadata may include historical data from devices which have previously interacted with the link based on network traffic. The metadata or information related to or representing the metadata may be presented directly to the user, or the appearance of the link may be altered based on risk score, user preferences, or network based protections. Further, a link and an alternative link may both be shown (for example, if a link was recently changed and the new link is not good, the old link may also be shown depending on user or the link owner's preferences.

Further additional aspects may include determining a viewing direction of the metaverse user, and wherein the determining the virtual content is further based at least in part on the viewing direction of the metaverse user. In some embodiments, a request may be received from the metaverse platform for the metaverse user to change the viewing direction.

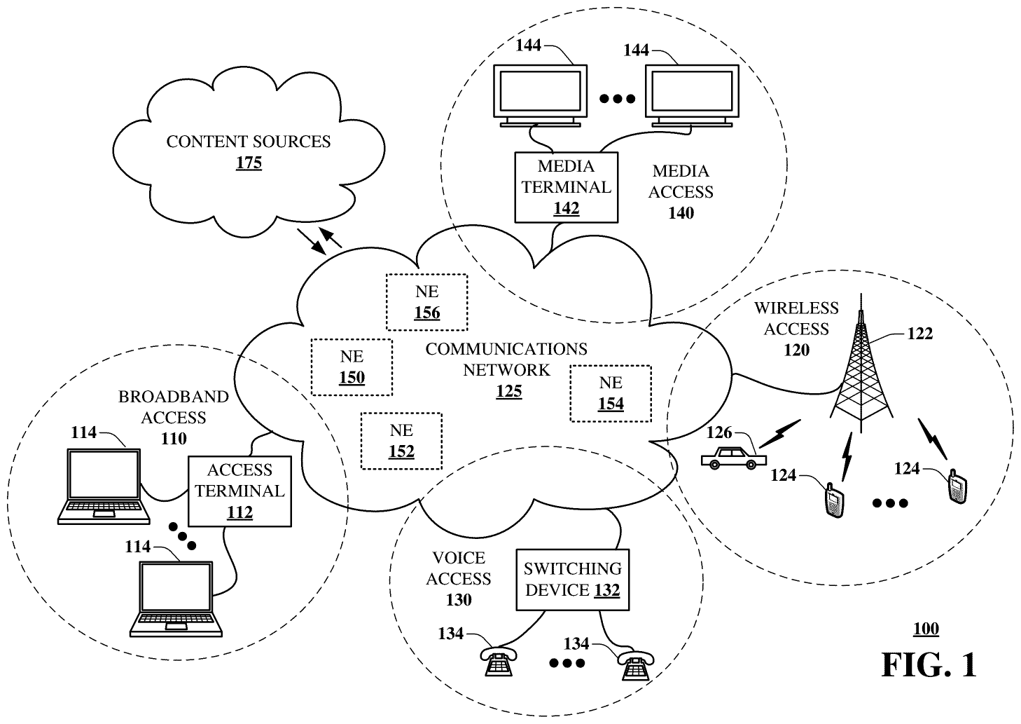

Referring now to FIG. 1, a block diagram is shown illustrating an example, non-limiting embodiment of a system 100 in accordance with various aspects described herein. For example, system 100 can facilitate in whole or in part providing virtual links to a metaverse user based at least in part on a physical location of the metaverse user. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

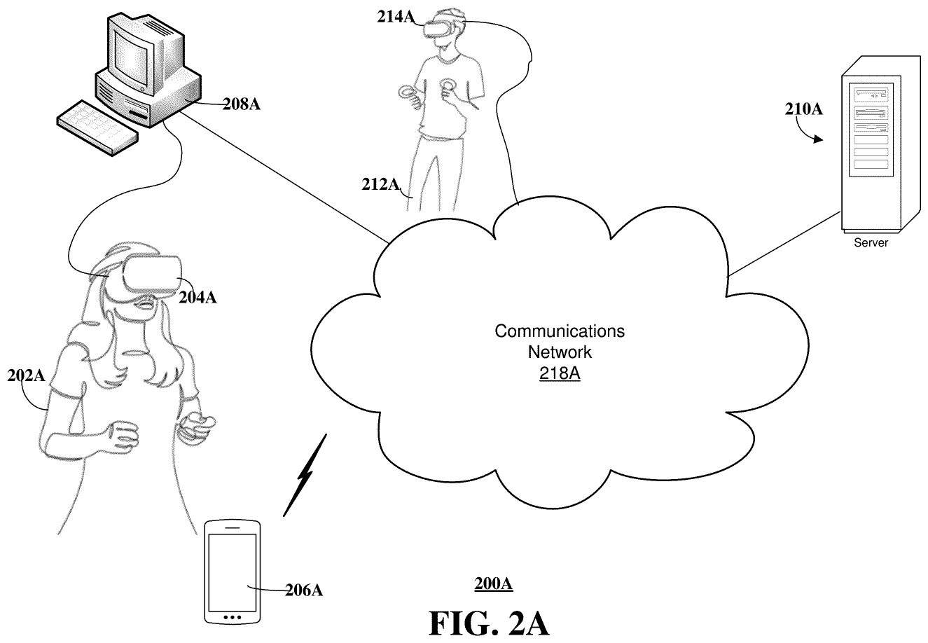

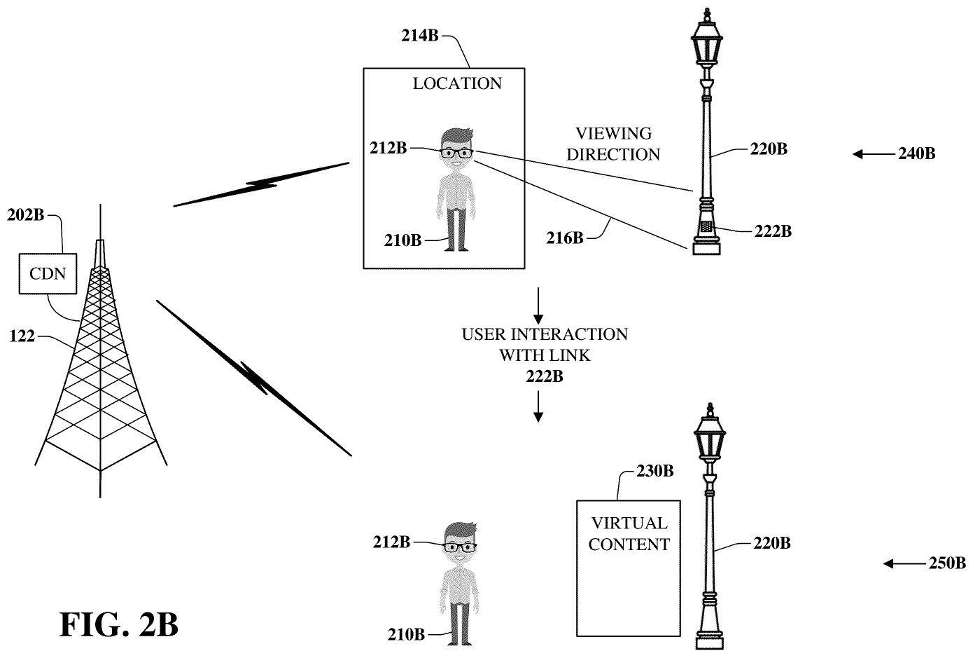

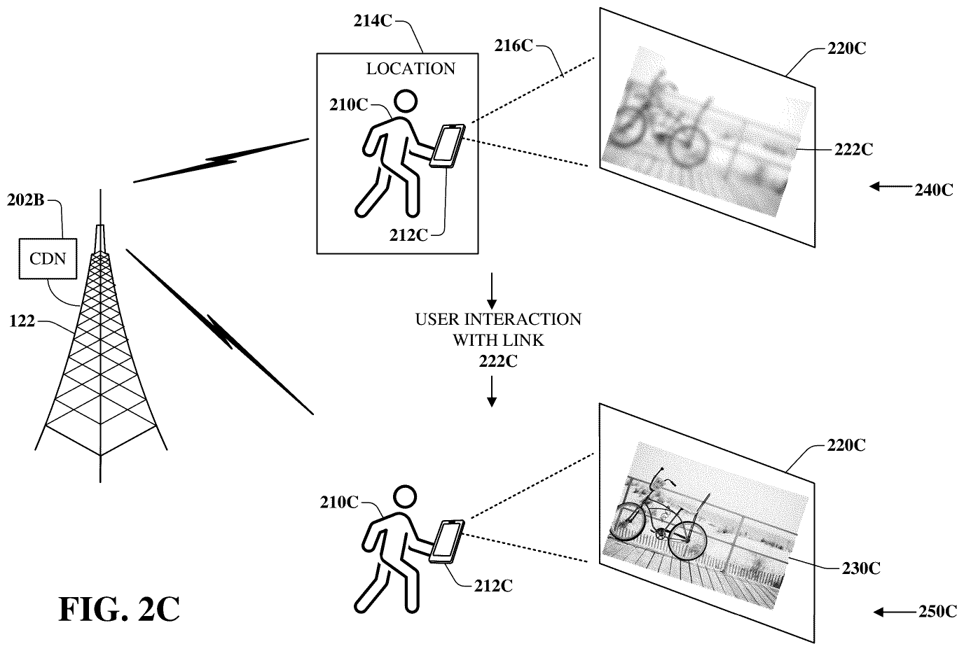

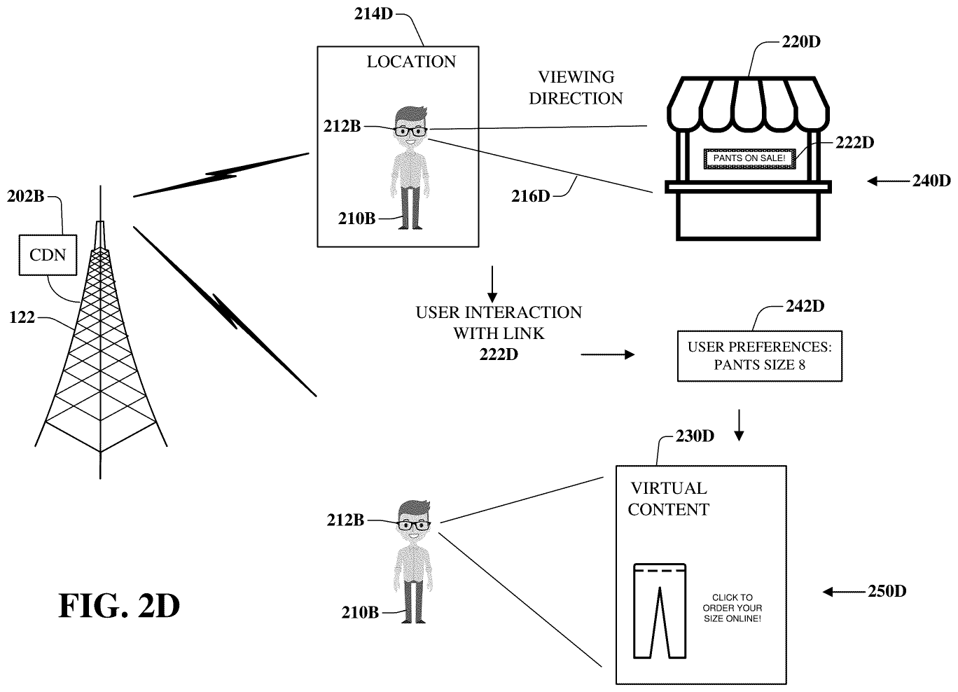

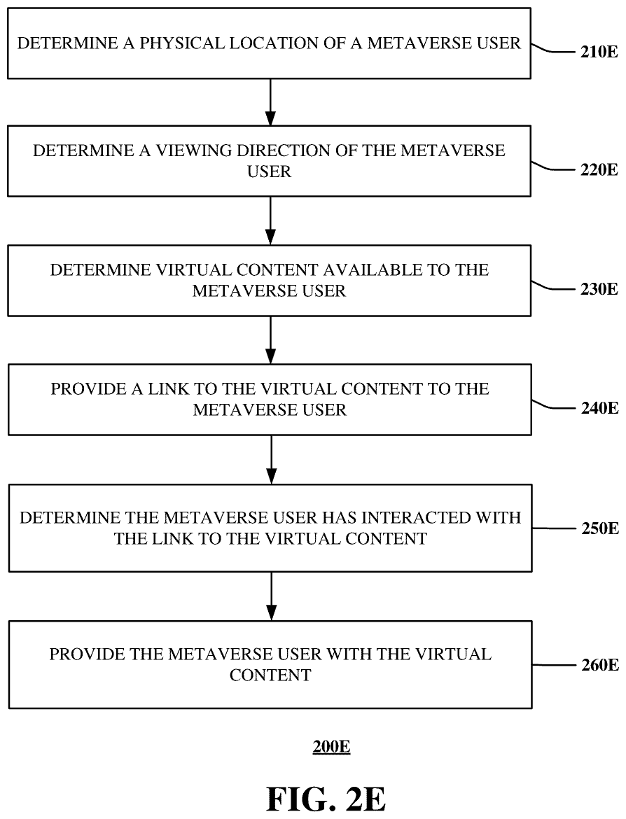

FIG. 2A is a block diagram illustrating an example, non-limiting embodiment of a system 200A functioning within the communication network of FIG. 1 in accordance with various aspects described herein.

In the exemplary embodiment of FIG. 2A, the system 200A includes extended reality (XR) headset 204A wearable by the metaverse user 202A, an XR headset 214A wearable by a metaverse user 212A, a user computer 208A and a metaverse platform 210A accessible over a communications network 218A. The system 200A of FIG. 2A may be used by one or more metaverse users such as metaverse user 202A and metaverse user 212A to participate in immersive experiences in one or more metaverses.

A metaverse includes a set of technologies that combine to create an immersive experience for one or more metaverse users. The immersive experience may occur in a persistent virtual world that continues to exist even after a metaverse user has left the virtual world. Metaverse worlds can be created using immersive reality (IR), augmented reality (AR), virtual reality (VR), mixed reality (MR) or extended reality (XR). These will be referred to collectively as XR herein, but the devices, concepts and techniques described herein may be extended to all similar or related technologies. In some examples, a metaverse experience can include an online or digital economy where metaverse users can create, buy, and sell goods and services.

A metaverse may be operated (created, managed, served, etc.) by any person or entity. One example of a metaverse is the metaverse promoted by Meta Platforms, Inc., but the various embodiments described herein are not limited to any particular metaverse or any particular metaverse provider or operator. A metaverse may include many virtual worlds and experiences that may be defined by participants, and the worlds may be accessed together or alone by respective participants. The participants generally access a metaverse using user equipment such as a VR headset, AR glasses or goggles, a smartphone, or the like.

The XR headset 204A and the XR headset 214A enables the user 202A and the user 212A to experience, generally, an XR environment, where XR is a general term intended to encompass XR, virtual reality (VR), mixed reality (MR) and augmented reality (AR) systems, equipment and environments. The XR headset 204A and the XR headset 214A generally include a data processing system including one or more processors, a memory for storing data and instructions, and a communication interface. The XR headset 204A and the XR headset 214A provide visual display to the user 202A and the user 212A and may include one or more display screens within the XR headset 204A and the XR headset 214A to control the view seen by the user 202A and the user 212A, as well as the environment experienced by the user 202A and the user 212A. Further, the XR headset 204A and the XR headset 214A may each include a camera for capturing images of the environment of the user. The XR headset 204A and the XR headset 214A may include speakers to provide sound information to the user 202A and the user 212A and the XR headset 204A and the XR headset 214A may include one or more microphones to collect sound information about the environment of the user 202A and the user 212A. In other embodiments, the XR headset 204A or the XR headset 214A may be embodied as AR glasses or goggles or other wearable devices or may be operated in conjunction with a fixed display system such as a computer monitor, television, or series of display screens in the physical environment with the user 202A or the user 212A.

In some embodiments, XR headset 204A and the XR headset 214A may include the ability to determine location and/or viewing direction. For example, an XR headset may include a GPS receiver, or may be able to determine its location in the physical world by communicating with a communication network such as communication network 218A. In some embodiments, an XR headset may be able to determine physical location when communicating with a 5G communications network. Also for example, an XR headset may include a compass, accelerometer, or any other sensor capable of providing viewing direction and/or change in viewing direction.

Further, in some embodiments, XR headset 204A and the XR headset 214A may include the ability to receive information describing the XR headset's physical location or and/or viewing direction. For example, an XR headset may receive location information and/or viewing direction information from a communication network or from a metaverse platform, or from any other source.

The user computer 208A is in data communication with one or both of the XR headset 204A and the XR headset 214A. In the illustrated embodiment, the user computer 208A has a wireline connection to the XR headset 204A. In other embodiments, the wireline connection may be supplemented or replaced with one or more wireless connections, such as a Wi-Fi connection according to the IEEE 802.11 family of standards or a Bluetooth connection according to the Bluetooth standard. In the example of FIG. 2A, the user computer 208A may have a wireless connection to the XR headset 214A or in some embodiments, the XR headset 214A may not communicate with the user computer 208A.

The user computer 208A cooperates with the XR headset 204A, and in some examples the XR headset 214A, to provide the XR environment for users including the user 202A. In some embodiments, the user computer 208A communicates with the XR headset 204A to provide video information, audio information and other control information to the XR headset 204A. Further, in some embodiments, the user computer 208A communicates with the metaverse platform 210A to provide video and other information from the XR headset 204A to the metaverse platform 210A. The video and data may be sent in any suitable format, including encoding to reduce the amount of data transmitted or encrypted to maintain security of the data. In some embodiments, the user computer 208A communicates to the XR headset 204A virtual reality information of a metaverse to the XR headset 204A. In some embodiments, the functionality provided by the user computer 208A may be combined with the XR headset 204A. In the embodiment of FIG. 2A, the user computer 208A is shown as a desktop computer. However, any suitable processing system, including one or more processors, memory, and communications interface, may implement the functions of the user computer 208A.

The smartphone 206A or any other user device is under control of the user 202A. The smartphone 206A is further in data communication with the communications network 218A, for example through a cellular network such as wireless access 120 (FIG. 1).

The metaverse platform 210A controls provision of one or more independent metaverse environments to the XR headset 204A for the user 202A and for the XR headset 214A for the user 212A. The metaverse platform 210A generally includes a processing system including one or more processors, a memory for storing data and instructions and a communications interface. The metaverse platform 210A may be implemented as a single server computer, as multiple server computers at one or multiple locations or in any suitable manner. In the system 200A, the metaverse platform 210A implements one or more metaverses that may be combined in some circumstances and according to particular rules.

The metaverse platform 210A receives over the communications network 218A information about the environment of the user 202A and the user 212A, including physical location information, information about objects in the environment and events occurring in the environment of the users. The user 202A and the user 212A may be in the same physical location or different physical locations. The user 202A and the user 212A may interact in the same independent metaverse or they may access different respective independent metaverses. The metaverse platform 210A in some embodiments may further receive information about the user 202A and the user 212A, including biometric information and information about the performance of the user 202A and the user 212A, user preferences, or user activity history. The information may come from the XR headset 204A, the XR headset 214A or any other source. Under control of the metaverse platform 210A, control information is provided over the communications network 218A including video information, sound information, haptic information and any other information, including instructions and data, to the other components of the system 200A including the user computer 208A, the XR headset 204A and the XR headset 214A.

The metaverse platform 210A develops a metaverse including an XR environment as a combination of the actual environment in which the user 202A is located and a simulated or virtual environment, to achieve ends such as training, entertainment, education, performance improvement, and behavioral improvement for the user 202A and the user 212A. In other embodiments, other metaverse platforms may create additional metaverses accessible by the user 202A, the user 212A and other users, not shown in FIG. 2A. Multiple users may engage each other in a metaverse generated and controlled by the metaverse platform 210A or by another metaverse source. Further, each user including the user 202A and the user 212A may be represented in a respective metaverse, such as by an avatar associated with the user.

The communications network 218A may include any combination of wireline and wireless communication networks, including but not limited to broadband access network 110, wireless access network 120, voice access network 130 and media access network 140 (FIG. 1). The communications network 218A may include the internet and may provide access to other devices and services as well.

FIG. 2B is a block diagram illustrating an example, non-limiting embodiment of a system providing a link to a metaverse user in accordance with various aspects described herein. In the example of FIG. 2B, metaverse user 210B uses XR device 212B to access a metaverse as described above with reference to FIG. 2A. XR device 212B is shown as a pair of glasses, although metaverse user 210B may use any XR capable device (e.g., headset, goggles, glasses, smartphone, etc.).

At 240B, XR device 212B is in communication with a wireless network as represented by base station 122. In some embodiments, XR device 212B communicates with a metaverse platform (e.g., metaverse platform 210A, FIG. 2A) over the wireless network. In the example of FIG. 2B, a metaverse user 210B accesses a virtual link 222B that is overlaid on the physical world in order to access virtual content. In some embodiments, the virtual link 222B is provided to metaverse user 210B when the metaverse user is at a specific physical location 214B. Also in some embodiments, the virtual link 222B may be provided to metaverse user 210B when metaverse user 210B has a specific viewing direction 216B. As described above with FIG. 2A, the location 214B of metaverse user 210B may be determined using the XR device 212B and/or a metaverse platform. In some embodiments, the physical location 214B of metaverse user 210B is determined by communicating with a 5G network or by utilizing a GPS receiver. The viewing direction 216B of metaverse user 210B may be determined using any information provided by any source. For example, XR device 212B may have a compass, accelerator, or other apparatus that provides direction information. Also for example, XR device 212B may receive viewing direction information from other sources of information, such as a metaverse platform, or an external device in the environment (not shown) such as a camera that can determine the viewing direction of metaverse user 210B.

Lamppost 220B is an example of a physical object in the physical world that metaverse user 210B may have in a field of view in viewing direction 216B. For example, metaverse user 210B may be in a city park identified by location 214B, and may have a viewing direction 216B to the southeast, thereby placing lamppost 220B in a field of view of metaverse user 210B. In some embodiments, XR device 212B and/or a metaverse platform may determine that when metaverse user 210B is at location 214B and has a viewing direction 216B, lamppost 220B should be within the field of view. When XR device 212B and/or a metaverse platform identifies the lamppost 220B within the field of view of metaverse user 210B, XR device 212B and/or the metaverse platform provides virtual link 222B within the field of view of metaverse user 210B. In this manner, the virtual link 222B is provided to metaverse user 210B when metaverse user 210B is at a specific location 214B and/or has a particular viewing direction 216B.

In some embodiments, virtual link 222B takes the form of a QR code, a button, a text string, a URL code, or the like. Virtual link 222B may take any form without departing from the various aspects described herein. In some embodiments, virtual link 222B also includes dynamic or static metadata. Metadata included as part of virtual link 222B may be visible to metaverse user 210B or may be nonvisible to metaverse user 210B. For example, metadata that describes the contents of the link or links statistics (e.g., how many clicks the link has received per unit time or the age of the link) may be provided within the field of view of metaverse user 210B so that metaverse user 210B may take the metadata into consideration when determining whether to interact with the link. In other embodiments, metadata may be embedded in the link such that it is not visible to the user. For example, metadata may be included as tags in a URL to further specify the content that will be presented to metaverse user 210B should metaverse user 210B interact with the virtual link.

In some embodiments, the metadata may include historical data from devices which have previously interacted with the link based on network traffic. The metadata or information related to or representing the metadata may be presented directly to the user, or the appearance of the link may be altered based on risk score, user preferences, or network based protections. Further, a link and an alternative link may both be shown (for example, if a link was recently changed and the new link is not good, the old link may also be shown depending on user or the link owner's preferences.

In some embodiments, a metaverse platform may determine the content to be presented to the metadata user based on location 214B and/or viewing direction 216B. For example, an advertiser may pay to display advertisements on lamppost 220B when a metaverse user has lamppost 220B in their field of view. Also for example, the city may provide digital artwork to be viewed on or near lamppost 220B at the metaverse user's discretion. As a result of determining the content that may be presented to a metaverse user, the virtual link 222B may be superimposed on the physical world such as shown at 240B where link 222B is superimposed on lamppost 220B.

In some embodiments, XR device 212B and/or a metaverse platform may take other criteria into consideration when determining whether to present a virtual link to a metaverse user. For example, rather than relying on just a location and/or viewing direction, a metaverse platform may take verification steps to determine that the physical environment matches that which is expected to be within the metaverse user's field of view. For example, when the metaverse platform determines that metaverse user 210B is at location 214B (e.g., the city park) with a particular viewing direction 216B (e.g., southeast), the metaverse platform may download to XR device 212B an image of a physical object expected to be within the field of view. In the example of 240B, a metaverse platform may download a low resolution image of lamppost 220B to XR device 212B and then the low resolution image may be matched to the real-world image of lamppost 220B to verify that metaverse user 210B is in fact in the desired location and has the desired viewing direction and that the desired physical objects are indeed in the metaverse user's field of view. In these embodiments, the virtual link 222B may be placed in the metaverse user's field of view after the physical object is determined to be in the metaverse user's field of view by matching it to the image downloaded to XR device 212B by a metaverse platform.

In some embodiments, imagery downloaded to XR device 212B is downloaded from a content delivery network (CDN) 202B. As used herein, the term content delivery network refers to distributed cloud storage that makes efficient use of bandwidth when communicating with endpoint devices. For example, the content delivery network 202B may include cloud storage at or near base station 122 that stores physical imagery of physical objects in the vicinity of base station 122 that might be expected to be provided to metaverse users when determining virtual links to be provided to the metaverse users. A base station with local CDN storage may serve the same data to any requesting user device. In this manner, the same imagery may not have to be repetitively provided across the network between a metaverse platform and one or more base stations, thereby saving bandwidth. In addition, in some embodiments, the virtual content is only provided to CDN locations in physical areas that are expected to be served that particular virtual content. In this manner, only metaverse users within the expected area may be served the virtual content, thereby providing additional security.

Metaverse user 210B may interact with virtual link 222B which has been superimposed on or near physical objects in the physical world such as lamppost 220B. Metaverse user 210B may interact with virtual link 222B in any manner. For example, virtual link 222B may be activated or followed by a prolonged gaze, a gesture, a head nod, a speech pattern, or in any other manner. When metaverse user 210B interacts with virtual link 222B, XR device 212B and/or a metaverse platform will provide virtual content 230B to metaverse user 210B as shown at 250B. In some embodiments, virtual content 230B may include an advertisement, digital artwork, text (e.g., a restaurant menu, directions to a venue, contact information, etc.), or any other type of content.

FIG. 2C is a block diagram illustrating an example, non-limiting embodiment of a system providing virtual content at various resolutions to a metaverse user in accordance with various aspects described herein. As shown in FIG. 2C, a metaverse user 210C utilizes an XR device 212C to interact with a metaverse. XR device 212C is shown as a smartphone, however XR device 212C may be any type of device capable of accessing information in a metaverse.

At 240C, metaverse user 210C is shown at a particular location 214C and having a particular viewing direction 216C. Surface 220C is an example of a physical object within a field of view of metaverse user 210C. In some embodiments, when metaverse user 210C holds XR device 212C with viewing direction 216C, metaverse user 210C may see virtual content superimposed on physical objects in the real world such as surface 220C. In the example of 240C, a low resolution image of artwork 222C is overlaid as a virtual image in the metaverse on the physical surface 220C. In some embodiments, the low resolution image of artwork 222C may be provided by a content delivery network 202B as described above with FIG. 2B.

An example of a low resolution image imposed on a physical surface may include artwork on a wall in a restaurant, a menu on a tabletop in a restaurant, or written reviews provided by past patrons on a window of a restaurant. In this manner, when metaverse user 210C is determined to be at the restaurant (location 214C), then as the metaverse user 210C changes his viewing direction 216C within the restaurant, various low resolution images will be provided to metaverse user 210C via XR device 212C. In some embodiments, the low resolution images such as image 222C may also function as virtual links. In these embodiments, when the metaverse user 210C interacts with the virtual link 222C, a higher resolution image such as that shown at 230C may be provided to XR device 212C for presentation to metaverse user 210C as shown at 250C. In some embodiments, XR device 212C provides an image of the physical object as well as a superimposed image of the digital artwork 230C. In these embodiments, in response to interacting with a low resolution image, the metaverse platform may provide an augmented image of the physical object to the metaverse user, where the augmented image of the physical object may include any additional virtual content, such as digital artwork, or other restaurant themed information as described above (e.g., menu, reviews, pictures of food, etc.).

In some embodiments, a low resolution image is provided to the XR device of the user, which then responds with information related to the field of view or objects within the field of view. For example, the metaverse platform may provide a low resolution image of a building to XR device 212C, and in response, XR device 212C may provide information (e.g., text or an image) describing or showing which windows are lit up. The metaverse platform may use this information for any purpose (e.g., to verify the metaverse user is currently at the desired location).

In some embodiments, the ability of a metaverse user 210C to view virtual content may be controlled or limited by additional information. For example, digital artwork may be licensed, and only those metaverse users having a license to view the digital artwork may be presented with the virtual link and/or the virtual content when the virtual link is followed.

As a further example, location 214C may correspond to a school room and the virtual content 230C may correspond to a licensed textbook. In these embodiments, a school may have a license that allows a particular number of textbook instances to be viewed simultaneously, and the ability of a metaverse user to view the virtual content (e.g., textbook) may be limited by the number of additional metaverse users accessing the virtual content at the same time. In these embodiments, image 222C may correspond to a picture of a textbook sitting on a desk, and virtual content 230C may correspond to the contents of the textbook being made available to metaverse user 210C after interacting with the virtual link.

FIG. 2D is a block diagram illustrating an example, non-limiting embodiment of a system providing virtual content to a metaverse user in accordance with various aspects described herein. Embodiments illustrated within FIG. 2D show user preferences and/or other user information being considered when providing virtual links and/or virtual content to a metaverse user based on criteria such as physical location and/or viewing direction. For example, as shown at 240D, metaverse user 210B, having been determined to be at location 214D and having viewing direction 216D, is provided with a virtual link 222D imposed on a physical object 220D in the physical world. In the example of FIG. 2D, the physical object is illustrated as a storefront 220D, however any physical object within the field of view of metaverse user 210B may be utilized. In some embodiments, user preferences for metaverse user 210B may be maintained by a metaverse platform, XR device 212B, or in any other manner (e.g., by an advertiser, a search engine provider, etc.). In response to user preferences, virtual link 222D may provide an advertisement for an object for sale. In the example at 240D the object is a pair of pants.

When metaverse user 210B interacts with virtual link 222D, user preferences 242D may be accessed to determine further information regarding metaverse user 210B, and virtual content 230D may be augmented, modified, or wholly determined based on user preferences 242D. In the example shown at 250D, the user preferences include a pants size and when metaverse user 210B interacts with virtual link 222D, virtual content 230D including an advertisement for a specific size of pants is provided to metaverse user 210B.

Any type of user information, including preferences, past purchase history, a user's personal information, address, or the like, may be utilized when determining virtual content to be presented to a metaverse user and when and where virtual links may be provided to a metaverse user.

FIG. 2E depicts an illustrative embodiment of a method in accordance with various aspects described herein. The actions of method 200E shown in FIG. 2E may be performed by any entity, device, or any combination of entities or devices. For example, the actions of method 200E may be performed by an XR device, a metaverse platform, a content delivery network, an advertiser, or any combination. Further, the actions of method 200E may be performed by a processor or a device that includes a processor that accesses instructions in a memory to perform operations.

At 210E of method 200E, a physical location of a metaverse user is determined. In some embodiments, a physical location is determined by an XR device when the XR device is communicating with a 5G network. In other embodiments, an XR device may include hardware capable of determining a physical location of the XR device, such as a GPS receiver. In other embodiments, other information may be utilized to determine a location of a metaverse user. For example, a metaverse user may have an XR device that is in communication with a smartphone held by the metaverse user, and the smartphone may provide physical location information to the XR device.

At 220E, a viewing direction of the metaverse user is determined. In some embodiments, a viewing direction may be determined using hardware wholly contained within the XR device, such as a compass, an accelerometer, or any other hardware capable of determining a viewing direction. In other embodiments, a viewing direction may be determined using information from outside an XR device. For example, a camera in the physical environment may observe a metaverse user and determine a viewing direction of the metaverse user using image recognition techniques.

In some embodiments, based on the physical location of the metaverse user and the viewing direction of the metaverse user, a metaverse platform may request that a metaverse user modify the viewing direction. For example, if the sun is low in the sky and it is determined that based on the location and viewing direction of the metaverse user, the user is looking into the sun, prior to providing a virtual link to the metaverse user, the metaverse platform may request that the metaverse user changed the viewing direction.

At 230E, virtual content to be made available to the metaverse user is determined. As described above, virtual content to be made available to a metaverse user may be determined using any number and/or type of criteria. Examples include the physical location of the metaverse user, the viewing direction of the metaverse user, past interactions between the metaverse user metaverse content, preferences of the metaverse user, or any other criteria.

At 240E, a link to the virtual content is provided to the metaverse user. In some embodiments, this includes superimposing a virtual link on a physical object in the physical world. In some embodiments, prior to providing the virtual link in the field of view of a metaverse user, an XR device and/or metaverse platform may perform additional actions to verify that the metaverse user is indeed viewing physical objects related to the intended virtual content. For example, a low resolution image of an object expected to be in the field of view of the metaverse user may be provided to an XR device used by the metaverse user and the image of the physical object may be matched to an actual physical object in the field of view prior to the virtual link being provided to the metaverse user.

In some embodiments, a virtual link may be provided as a low resolution image and when a metaverse user interacts with the low resolution image, virtual content may be provided as a higher resolution image. Further, a virtual link may include any amount or type of metadata. For example, metadata may describe preferences of the user past interactions of the user, or information regarding the link.

At 250E, a determination is made that the metaverse user has interacted with the virtual link to the virtual content, and AT260E the virtual content is provided to the metaverse user.

While for purposes of simplicity of explanation, the respective processes are shown and described as a series of blocks in FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

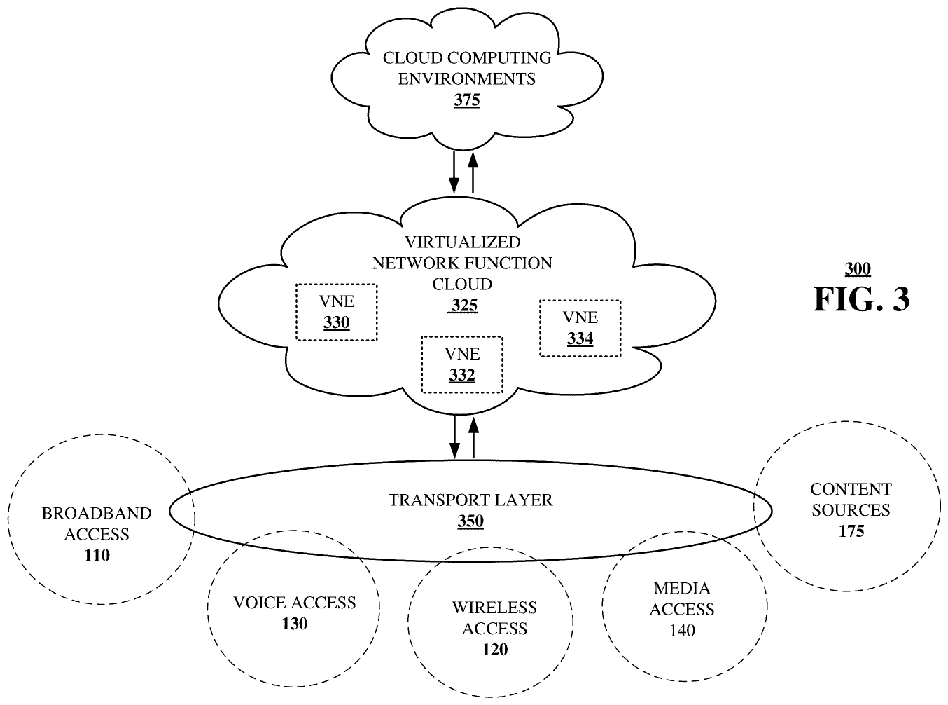

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions described with reference to the previous FIGS. For example, virtualized communication network 300 can facilitate in whole or in part providing virtual links to a metaverse user based at least in part on a physical location of the metaverse user.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

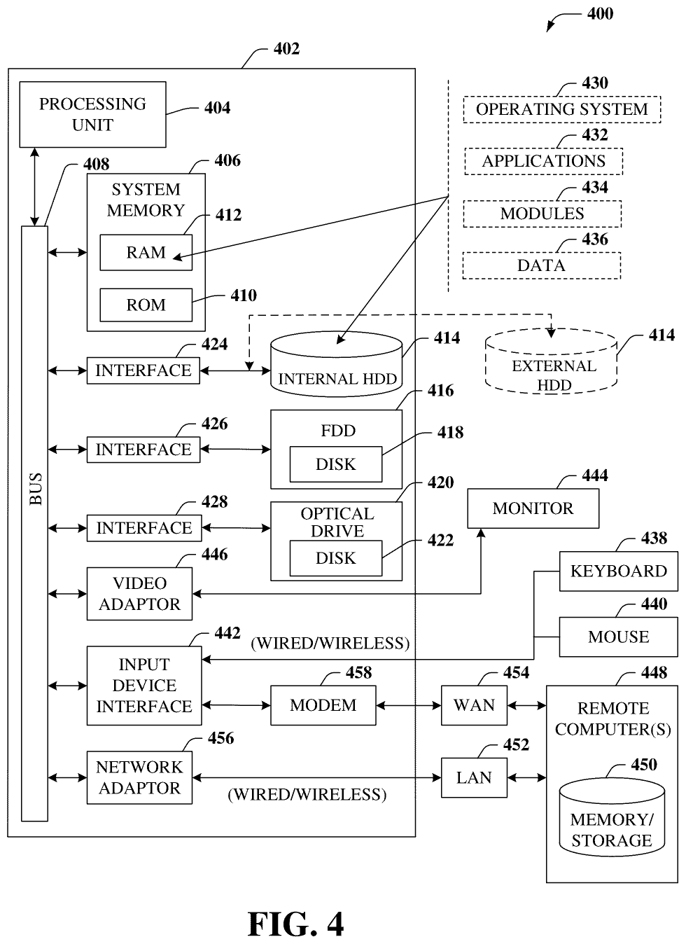

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part providing virtual links to a metaverse user based at least in part on a physical location of the metaverse user.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

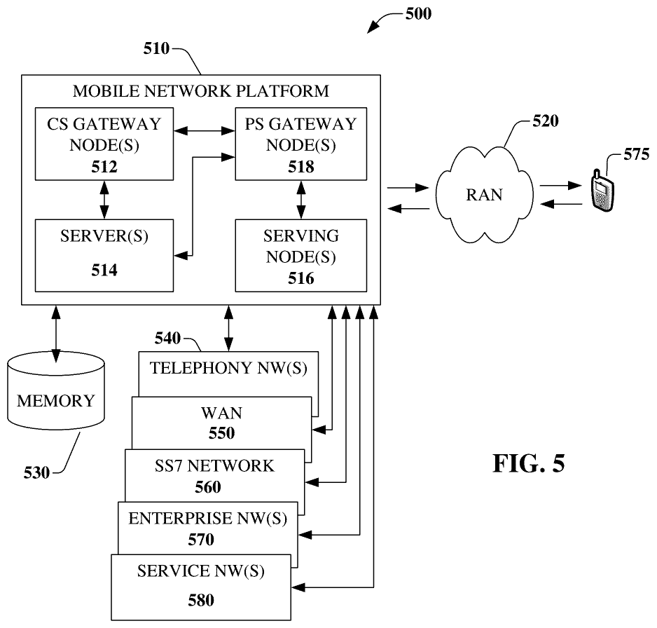

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part providing virtual links to a metaverse user based at least in part on a physical location of the metaverse user. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

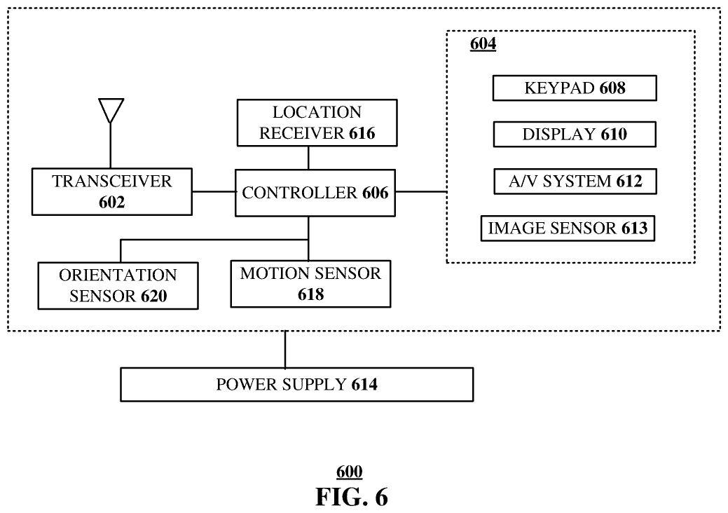

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part providing virtual links to a metaverse user based at least in part on a physical location of the metaverse user.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
determining a physical location of a metaverse user;
based at least in part on the physical location of the metaverse user, determining virtual content to be made available to the metaverse user; and
providing, to the metaverse user, a link to the virtual content.

2. The device of claim 1, wherein the operations further comprise identifying a physical object in a field of view of the metaverse user, and wherein the determining the virtual content is further based at least in part on the physical object in the field of view.

3. The device of claim 2, wherein the operations further comprise presenting an image of the physical object to the metaverse user at a first resolution.

4. The device of claim 3, wherein the operations further comprise, in response to the metaverse user interacting with the link to the virtual content, presenting an augmented image of the physical object to the metaverse user at a second resolution, wherein the second resolution is higher than the first resolution.

5. The device of claim 4, wherein the augmented image includes digital artwork.

6. The device of claim 1, wherein the determining the physical location of the metaverse user comprises communicating with a 5G network.

7. The device of claim 1, wherein the operations further comprise:
determining metadata associated with the link; and
presenting the metadata to the metaverse user along with the link.

8. The device of claim 7, wherein the metadata comprises an age of the link, an access frequency of the link, a total number of accesses of the link, historical data from devices which have previously interacted with the link, or any combination.

9. The device of claim 1, wherein the operations further comprise determining a viewing direction of the metaverse user, and wherein the determining the virtual content is further based at least in part on the viewing direction of the metaverse user.

10. A non-transitory machine-readable medium, comprising executable instructions that, when executed by a processing system including a processor, facilitate performance of operations, the operations comprising:
determining a physical location of a metaverse user;
determining a viewing direction of the metaverse user; and
based at least in part on the physical location and the viewing direction of the metaverse user, providing, to the metaverse user, a link to virtual content associated with an object in a field of view of the metaverse user.

11. The non-transitory machine-readable medium of claim 10, wherein the determining the physical location of the metaverse user comprises communicating with a 5G network.

12. The non-transitory machine-readable medium of claim 10, wherein the operations further comprise:
determining metadata associated with the link; and
presenting the metadata to the metaverse user along with the link.

13. The non-transitory machine-readable medium of claim 12, wherein the metadata comprises an age of the link, an access frequency of the link, a total number of accesses of the link, or any combination.

14. The non-transitory machine-readable medium of claim 10, wherein the operations further comprise providing feedback to the metaverse user to change the viewing direction.

15. A method, comprising:
determining, by a processing system including a processor, a physical location of a metaverse user;
providing, by the processing system, the physical location to a metaverse platform;
receiving, by the processing system, a link to virtual content;
providing, by the processing system, an indication to the metaverse platform that the metaverse user has interacted with the link to the virtual content; and
receiving, by the processing system, the virtual content from a content delivery network.

16. The method of claim 15, wherein the receiving the link to the virtual content comprises receiving an image of a physical object in a field of view of the metaverse user.

17. The method of claim 16, wherein the receiving the virtual content comprises receiving an augmented image of the physical object.

18. The method of claim 17, wherein the augmented image includes digital artwork.

19. The method of claim 15, further comprising:
determining, by the processing system, a viewing direction of the metaverse user; and
providing, by the processing system, the viewing direction of the metaverse user to the metaverse platform.

20. The method of claim 19, further comprising receiving, by the processing system, a request from the metaverse platform for the metaverse user to change the viewing direction.
